(19) United States
(12) Patent Application Publication
(10) Pub. No.: US 2017/0314537 A1
(43) Pub. Date: Nov. 2, 2017

(54) SYSTEM AND METHOD FOR ADDING OIL TO WINDMILL GEAR BOX

(71) Applicant: Edward Johnson, Lenora, KS (US)

(72) Inventor: Edward Johnson, Lenora, KS (US)

(21) Appl. No.: 15/497,664

(22) Filed: Apr. 26, 2017

Related U.S. Application Data
(60) Provisional application No. 62/329,704, filed on Apr. 29, 2016.

(51) Int. Cl. F03D 80/70; F16H 57/04; F03D 15/00

(52) U.S. Cl. CPC F03D 80/70; F16H 57/045; F16H 57/0434; F03D 15/00; F16H 57/042; F05B 2260/40311

(57) ABSTRACT

A system and method for adding oil to the gearbox of a water pump windmill includes a tubular head lift rod in the gearbox attached to a tubular tower lift rod. Pressurized oil introduced into the tower lift rod flows through an interior passageway in the tower lift rod, to an interior passageway in the head lift rod, and out an oil dispersion aperture in the head lift rod and into the gearbox. The system allows a user to add oil to a windmill gearbox located at the top of a windmill tower from ground level by propelling the oil through the tower lift rod and head lift rod. Also disclosed is an accompanying method.

### CROSS-REFERENCE TO RELATED APPLICATIONS

This application claims the benefit of U.S. Provisional Patent Application No. 62/329,704, filed Apr. 29, 2016, the disclosure of which is hereby incorporated herein in its entirety by reference.

### FIELD OF THE INVENTION

The present invention relates generally to windmills. More specifically, the invention relates to a system for adding oil to the gearbox of a water pump windmill.

### BACKGROUND

Windmills have been used to convert wind power to a usable form of energy for centuries. Typical windmills include a wind wheel assembly comprising a plurality of blades, sails, or impellers that translate generally straight-line wind energy into a rotary motion. That rotary motion is typically used to directly drive a gearbox that transfers that energy to a rotary shaft for driving various rotary implements, such as generators to provide electrical power, alternatively, the gearbox can convert that rotary motion to linear motion to drive a variety of mechanical devices.

One common use of windmills is to drive water pumps to draw underground water to the surface for use in providing water to farm animals or irrigation water to plants. Such water pump windmills are ubiquitous in the plain states of the United States and throughout the world as they can be left to run generally unattended, pumping water whenever the wind blows.

A typical water pump windmill includes a tower extending twenty to fifty feet or more above the ground, with a wind wheel assembly mounted to a gearbox at the top of the tower. The gearbox translates the rotary motion of the wheel assembly to a linear, up-and-down motion, driving a solid head lift rod that extends downwardly and out the bottom of the gearbox housing through a series of seals. The head lift rod connects to a rod or tube extending downwardly from the gearbox, to an underground or above ground water pump. When the wind blows, rotation of the wheel assembly at the top of the tower drives the gearbox, which translates the rotary motion to linear, up-and-down motion that drives the head lift rod. Movement of the head lift rod operates the tower lift rod which drives the piston of the water pump which in turn draws water upwardly from the ground. A water discharge pipe directs the pumped water to a desired location, such as a trough for watering animals, to an irrigation system, for watering plants, or wherever else desired.

While relatively simple, the gearbox of the water pump windmill bears the brunt of the duty in the windmill and includes numerous interacting gears and linkages that all require lubrication. Typically, the gear box includes a closed lower housing or case in which the gears and linkages are located. The case is filled with oil to provide lubrication to the gears and linkages as the windmill is in operation. Maintenance of the gearbox involves periodically adding oil to, and/or replacing the oil in the gearbox. That periodic maintenance requires a user to climb the tower carrying tools and sufficient oil to fill the gearbox, remove the bonnet covering the gear box, add oil, replace the bonnet, and climb back down the tower. As is known in the industry, such maintenance is dangerous as it occurs with a maintenance technician situated at the top of the windmill tower and requires the technician to manipulate the tools and oil cans necessary to refill the gearbox, all while perched at the top of the tower ladder.

Thus, it can be seen that there remains a need in the art for a system for adding oil to the gearbox of a water pump windmill that is easier, more efficient, and less dangerous than the methods currently known in the art.

### SUMMARY

Embodiments of the invention are defined by the claims below, not this summary. A high-level overview of various aspects of the invention is provided here to introduce a selection of concepts that are further described in the Detailed-Description section below. This summary is not intended to identify key features or essential features of the claimed subject matter, nor is it intended to be used in isolation to determine the scope of the claimed subject matter. In brief, this disclosure describes, among other things, a system for adding oil to the gearbox of a water pump windmill from ground level, without requiring a service technician to climb a ladder or tower to reach the gearbox.

The present invention is directed to a system for adding oil to the gearbox of a water pump windmill. In an exemplary embodiment, the system includes a hollow tubular head lift rod configured and fitted within a gearbox of a windmill. The hollow head lift rod replaces a conventional solid head lift rod in the gearbox, connecting at an upper end to the interior gearing of the gearbox, and extending downwardly, out the bottom of the gearbox housing to transfer the linear, up-and-down motion from the gearbox. As will be apparent in conjunction with description below, the hollow head lift rod allows oil to be introduced into the gear box through the head lift rod.

The lower end of the hollow head lift rod extends downwardly and out the bottom of the gearbox, and connects to the upper end of a likewise hollow tower lift rod that extends downwardly from the head lift rod, all the way down the center of the windmill tower, and connects to a water pump drive rod at the lower end of the tower.

A pressurized oil tank connects via a hose or line to the lower end of the hollow tower lift rod so that an operator of the system can supply pressurized oil into the tower lift rod. The pressurized oil flows up through the hollow tower lift rod, into the hollow head lift rod, and is dispersed into the gearbox through an aperture in the head lift rod.

Thus, oil can be added to the gearbox from ground level by applying the pressurized oil from the tank at ground level, without the need for a user to climb the tower and manually add oil to the gearbox.

### DESCRIPTION OF THE DRAWINGS

Illustrative embodiments of the invention are described in detail below with reference to the attached drawing figures, and wherein:

FIG. 1 is a front view of a prior art water pump windmill.

FIG. 2 is a side view of a portion of a prior art windmill gearbox assembly.

FIG. 3 is a perspective view of a system for adding oil to the gearbox of a windmill in accordance with an exemplary embodiment of the present invention.

FIG. 4 is a perspective view of a windmill gearbox assembly having a hollow head lift rod in accordance with an exemplary embodiment of the present invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

Embodiments of the invention include apparatus and systems for adding oil to the gear box of a water pump windmill. Various embodiments of the present invention are disclosed herein, it is to be understood that the disclosed embodiments are merely exemplary of the invention, which may be embodied in various forms. Thus, any specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology used in the following description is for convenience in reference only and is not limiting. For example, the words “vertically”, “horizontally”, “vertical”, “horizontal” and “upwardly”, “downwardly”, “upper”, “lower” all refer to the installed position of the item to which the reference is made. The words “inwardly” and “outwardly” refer to directions toward and away from, respectively, the geometric center of the embodiment being designated and parts thereof. The terminology used herein may include the words specifically mentioned, derivatives thereof and words of a similar import. It is further understood that terminology such as the aforementioned directional phrases may be used to describe exemplary embodiments of the system for adding oil to the gearbox of a water pump windmill as shown in the figures herein, specifically with the gearbox positioned vertically above the water pump. This is for convenience only as it is understood that the exemplary embodiments of the system described may also be used at angles other than precisely vertical, and where the gearbox may be offset from the windmill and/or the water pump.

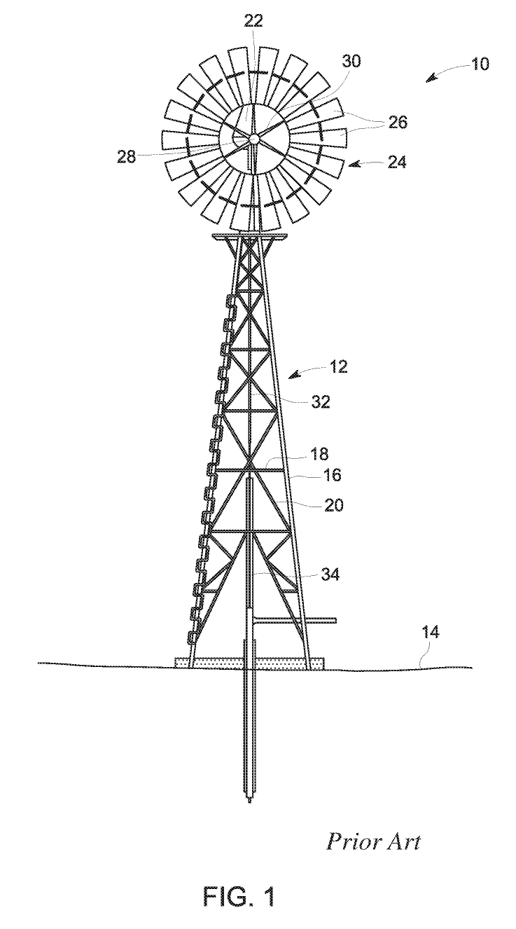

Looking first to FIG. 1, a depiction of an exemplary water pump windmill as is known in the prior art is depicted generally by the numeral 10. The prior art windmill includes a tower 12 extending upwardly from the ground or surface 14, typically to a height of twenty to fifty feet. The tower 12 structure comprises a plurality of support legs 16 extending from the ground to the top of the tower, connected by a series of cross bars 18 and diagonal braces 20.

A gearbox 22 is mounted at the top of the tower, with a wind wheel assembly 24 attached to a driveshaft extending generally horizontally from the gearbox. The wind wheel assembly 24 comprises a series of blades or sails 26 arranged circumferentially around a center hub 28 via a series of connecting arms 30. The center hub 28 is attached to the solid driveshaft extending from the gearbox 22 such that rotation of the wind wheel causes rotation of the driveshaft.

Looking still to FIG. 1, a solid tower lift rod 32 extends downwardly from the gearbox to a water pump drive rod 34 near ground level. The upper end of the tower lift rod 32 is attached to a head lift rod extending downwardly from the bottom of the gearbox 22, while the lower end of the tower lift rod is attached to the water pump drive rod 34 at the bottom of the tower. Thus, linear up-and-down motion from the gearbox is transferred via the head lift rod (internal to and extending out the bottom of the gearbox), to the tower lift rod 32 and in turn is transferred to the water pump drive rod 34 which operates a piston of water pump positioned underground or at the base of the tower to pump water from underground to the surface.

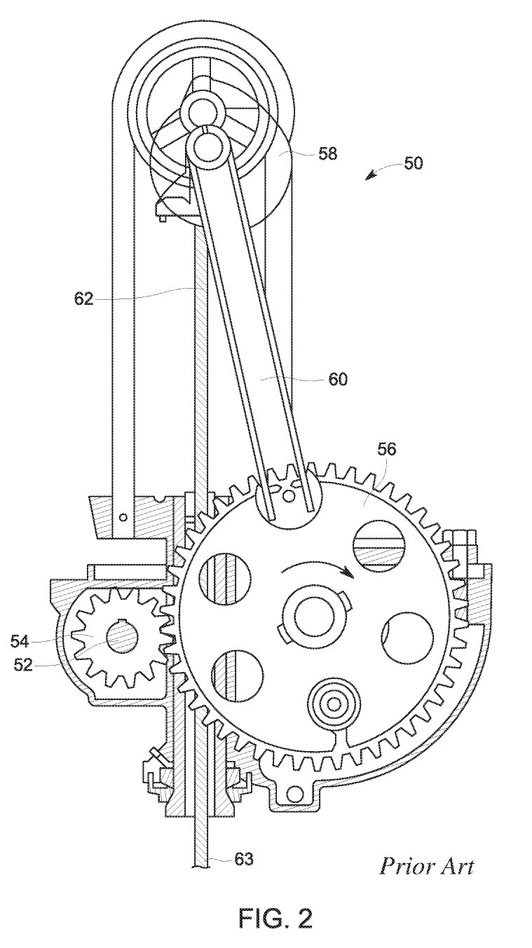

Turning to FIG. 2, the internal gearing of an exemplary prior art windmill gearbox is depicted generally as numeral 50. The windmill gearbox includes a driveshaft 52 attached at one end to a drive gear 54. As discussed previously with reference to FIG. 1, the center hub 28 of the wheel assembly 24 attaches to the outer end of the driveshaft 52 so that rotation of the wheel assembly rotates the drive shaft 52, which turns drive gear 54.

The drive gear 54 turns a driven gear 56 which is connected to a guide assembly 58 via a pitman arm 60. Also attached to guide wheel 58 is the upper end of a head lift rod 62, with the lower end 63 of the head lift rod 62 extending outwardly from the bottom of the gearbox through a series of one or more seals to prevent oil from leaking around the protruding head lift rod. As discussed previously with respect to FIG. 1, the lower end of the head rod attaches to the upper end of the tower lift rod 32 so that the linear up-and-down motion of the head lift rod is transferred down the tower and to the water pump connected at the lower end of the tower lift rod. As is known in the art, the head lift rod 62 used in a conventional windmill gearbox is typically a solid cylindrical piece.

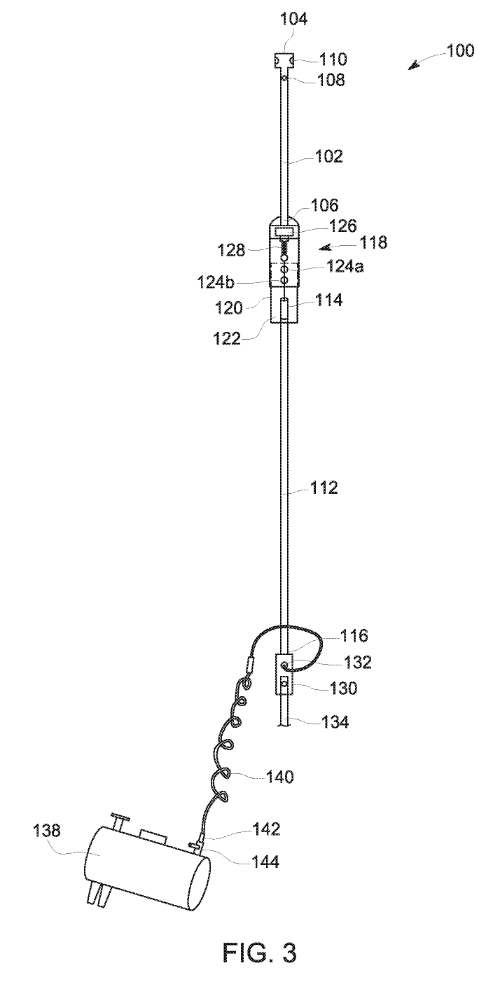

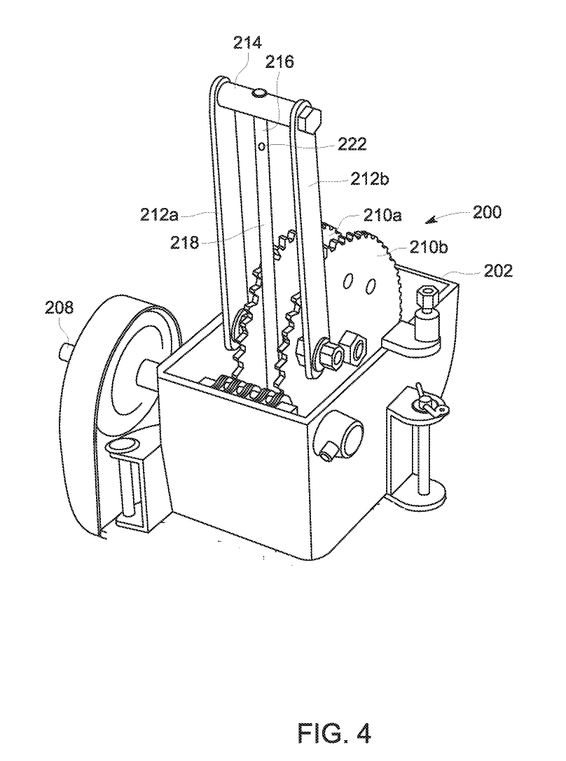

With the components and operation of the prior art windmills set forth, an exemplary embodiment of a system and method of the present invention will now be described with reference to FIGS. 3 and 4.

Turning first to FIG. 3, a system for adding oil to the gearbox of a windmill water pump in accordance with an exemplary embodiment of the present invention is depicted by the numeral 100. The system includes a hollow, tubular, head lift rod 102 for a windmill gearbox extending between upper 104 and lower 106 ends. The hollow interior of the head lift rod 102 allows oil to flow through the rod as will be described in more detail below. An aperture 108 formed in the head lift rod 102 near the upper end 104 is in fluid communication with the interior passageway of the head lift rod 102 rod so that pressurized oil introduced into the lower end 106 of the rod flows upwardly, through the interior passageway, and out the aperture, into the gearbox can flow from the interior passageway, through the aperture, and into the gearbox. It should be understood that the head lift rod 102 is employed as a part of a complete gearbox in a manner similar to that previously described with respect to the prior art gearbox of FIG. 2, with the head lift rod 102 taking the place of the solid head lift rod known in the prior art. Looking still to FIG. 3, a connecting hole 110 extends through the upper end 104 of the head lift rod and is configured to allow the head lift rod to be attached to a guide assembly within a windmill gearbox using a bolt, screw, or other fastener. In one preferred embodiment, the head lift rod 102 comprises a five-eighths inch tubing, with a one-quarter inch oil dispersing aperture 108 formed near the upper end. In another embodiment, the connecting hole 110 is formed through a fitting or junction attached to the upper end 104 of the rod 102. Preferably, the head lift rod 102 if formed of a strong, rigid material, such as steel or metal.

Looking still to FIG. 3, a hollow, tubular, tower lift rod 112 extends between an upper end 114 and a lower end 116, with an interior passageway extending the length of the tower lift rod 112. In one exemplary embodiment, the tower lift rod comprises a five-eighths inch tubing. It should be understood that while the tower lift rod 112 is depicted as a single piece that it may be comprised of multiple pieces of tubing connected via tubular couplers.

A generally tubular rotatable coupler connector 118 attaches the lower end 106 of the head lift rod 102 to the upper end 114 of the tower lift rod 112 so that the interior passageway of the head lift rod 102 is in fluid communication with the interior passageway of the tower lift rod 112 so that pressurized oil can flow upwardly through interior passageway of the tower lift rod 112, through the rotatable coupler connector 118, into and through the interior passageway of the head lift rod 102, and out the aperture 110 formed in the upper end 104 of the head lift rod 102.

The lower portion of the rotatable coupler adapter 118 comprises a threaded collar 120 attached to a flat piece of iron 122, with two apertures 124a, 124b configured to receive bolts for attaching the rotatable coupler adapter 118 to the upper end 114 of the tower lift rod 112. The upper portion of the rotatable coupler adapter 118 attaches to the lower end 106 of the head lift rod 102 through a rotator washer 126. An interior oil line 128 connects between the lower end 106 of the head lift rod 102 and the upper end 114 of the tower lift rod 112 to transmit oil flow from the upper end 114 of the tower lift rod 112, through the rotatable coupler adapter 118, and into the lower end 106 of the head lift rod 102. The rotatable couple adapter 118 allows the tower lift rod 112 to rotate and/or flex in relationship to the head lift rod 102 with the interior oil line 128 ensuring fluid communication for oil flow between the tower lift rod 112 and the head lift rod 102. In alternative embodiments the tower lift rod 112 may be coupled directly to the head lift rod 102, or the rotatable coupler adapter 118 may employ other means to provide fluid communication between the tower lift rod and the head lift rod.

A coupler 130 attached at the lower end 116 of the tower lift rod 112 includes an inlet aperture 132 for introducing pressurized oil into the interior passageway of the tower lift rod 112. The coupler 130 is a generally flat piece of iron bolted to the tower lift rod 112 and to the water pump drive rod 134 to secure the two together.

Thus, with the lower end 106 of the head lift rod 102 connected to the top of the rotatable coupler adapter 118, the upper end 114 of the tower lift rod 112 connected to the bottom of the rotatable coupler adapter 118, and the water pump drive rod 134 connected to the lower end 116 of the tower lift rod 112, the linear up-and-down motion of the gearbox is transferred to a water pump in a manner similar to that of a conventional windmill water pump. However, unlike systems known in the prior art, the hollow tubular tower lift rod 112 and head lift rod 102, and rotatable coupler adapter 118 of the exemplary embodiment of the present invention depicted in FIG. 3 form a continuous interior passageway to allow pressurized oil to be conveyed from ground level (i.e., where the tower lift rod 112 attaches to the water pump drive rod 134) to the head lift rod 102 located in the windmill gearbox at the top of a windmill tower, with the oil flowing from the outlet aperture 108 into the gear box assembly as will now be described in more detail.

Looking to FIG. 4, a gearbox for a water pump windmill in accordance with an exemplary embodiment of the present invention is depicted generally by the numeral 200. The gearbox is similar in structure and operation to the gearbox previously described with respect to the prior art in FIGS. 1 and 2. The gearbox 200 includes a housing 202 that contains the gear mechanisms and defines an interior cavity that is filled with oil to provide lubrication to the gear assembly.

The gearbox assembly includes a driveshaft 208 that is attached to a wind wheel which provides rotary motion into the gearbox. One or more internal drive gears (not shown) drive the driven gears 210a, 210b, each attached to a pitman arm 212a, 212b, attached between the corresponding driven gear and a guide assembly 214. The guide assembly 214 attaches to the upper end 216 of a hollow, tubular head lift rod 218 which extends downwardly and through the bottom of the housing. Thus, in a manner similar to that as described previously with respect to FIGS. 1 and 2, rotary motion from a wind wheel is transferred to drive shaft 208 which rotates a drive gear within the gearbox. The drive gear engages one or more driven gears 210a, 210b which rotate and drive pitman arms 212a, 212b which in turn raise and lower the guide assembly 214 that converts the rotational motion of the drive shaft to a linear, up-and-down motion, attached to the upper end of the head lift rod 218. Thus, as the drive shaft 208 turns, the rotary motion from the wind wheel is converted to linear up-an-down motion driven by head lift rod 218. An oil dispersing aperture 222 near the upper end of hollow tubular head lift rod 218 allows oil transported through the head lift rod to expel into the gearbox area, with the oil flowing downwardly to fill the housing with oil.

With the structure of the gearbox, head lift rod, and tower lift rod set forth, the operation of a system in accordance with an exemplary embodiment of the present invention will now be described with reference to FIGS. 3 and 4.

Looking first to FIG. 3, the outlet port 142 of an oil tank 138 is connected through a shut-off valve 144 via an oil line 140 to the inlet aperture 132 at the bottom of the tower lift rod 112. As previously described, the inlet aperture 132 is in fluid communication with the interior passageway of the tower lift rod 112. Preferably, the oil tank 138 is filled with a quantity of oil for distribution to the outlet port 142 and with the inlet side pressurized to a desired air, or other gas, pressure such that the oil in the tank is likewise pressurized.

With the tank thus pressurized and connected, the shut-off valve 144 is opened so that pressurized oil flows from the tank 138, through the oil line 140 and into the inlet aperture 132. The oil flows into the coupler and up through the interior passageway of the tower lift rod 112, up through the rotatable coupler adapter 118, and into the interior passageway of the hollow tubular head lift rod 102. The oil flows up through the head lift rod 102 and out the oil dispersing aperture 108 at the top of the head lift rod.

As seen in the exemplary embodiment of FIG. 4, within the gearbox, pressurized oil will flow out of the aperture 222 in the head lift rod and down into the gearbox housing 202, thus filling the housing with oil. The oil can be filled until it begins to overflow the housing and the operator of the system stops the flow. In alternative embodiments the housing can be configured with a gauge or float indicator that provides a visual indication of the oil level within the housing. It should further be understood that in use the gearbox housing 202 will typically include a bonnet or cover that entirely encloses the upper portion of the gearbox and the gear assembly.

Thus, it can be seen that the system of the present invention is well adapted to overcome the shortcomings of the prior art. In known windmill gearbox designs, the head lift rod and tower lift rods are typically solid, with no interior passageways and a user must climb a windmill tower to add oil to the gearbox housing. The system and method of the present invention allows a user to add oil to the gearbox from ground level, without having to climb the windmill tower.

It should be understood that while certain forms and embodiments have been illustrated and described herein, the present invention is not to be limited to the specific forms or arrangement of parts described and shown, and that the various features described may be combined in ways other than those specifically described without departing from the scope of the present invention. The terms “substantially”, “generally”, “approximately”, or any other qualifying term as used herein may be applied to modify any quantitative representation which could permissibly vary without resulting in a change to the basic function to which it is related. For example, the drive shaft of the gearbox is described as being generally horizontal, but may permissibly vary from that configuration if the variance does not materially alter the capability of the invention.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed is:

1. A system for adding oil to a gearbox of a windmill, comprising:
a hollow tubular head lift rod for a windmill gearbox having an interior passageway and an oil dispersing aperture in fluid communication with the interior passageway;
a hollow tubular tower lift rod in fluid communication with the head lift rod such that pressurized oil introduced into the tower lift rod flows thorough the tower lift rod, through the head lift rod, and out the oil dispersing aperture into the gearbox.

2. The system of claim 1, further comprising a rotatable adapter coupler configured to attach the tower lift rod and the head lift rod in fluid communication.

3. The system of claim 2, wherein the rotatable adapter coupler comprises an interior oil line.

4. The system of claim 1, further comprising a tower rod coupler configured to attach to a lower end of the tower lift rod, wherein said tower rod coupler comprises an inlet aperture for introducing pressurized oil into an interior passageway of the tower rod.

5. The system of claim 1, further comprising an oil tank adapted to attach in fluid communication to the tower rod.

6. A system for adding oil to a gearbox of a windmill, comprising:
a windmill gearbox comprising a hollow tubular head lift rod, wherein the head lift rod comprises an interior passageway and an oil dispersing aperture in fluid communication with the interior passageway;
a tubular tower lift rod having an interior passageway connected in fluid communication with the interior passageway of the head lift rod such that pressurized oil introduced into the tower lift rod flows thorough the tower lift rod, through the head lift rod, and out the oil dispersing aperture into the gearbox.

7. The system of claim 6, further comprising a rod coupler configured to attach the tower lift rod and the head lift rod in fluid communication.

8. The system of claim 7, wherein the rod coupler is a rotatable coupler adapter configured to allow the tower lift rod to rotate in relationship to the head lift rod.

9. The system of claim 6, wherein the tower lift rod comprises an inlet aperture for introducing pressurized oil into an interior passageway of the tower rod.

10. The system of claim 6, further comprising an oil tank adapted to attach in fluid communication to the tower rod.

11. A method for adding oil to a gearbox of a windmill, comprising:
providing a hollow tubular head lift rod for a windmill gearbox, wherein the head lift rod comprises an interior passageway and an oil dispersing aperture in fluid communication with the interior passageway;
attaching a tubular tower lift rod having an interior passageway in fluid communication with the head lift rod; and
introducing pressurized oil into the tower lift rod such that oil flows through the tower lift rod, the head lift rod, and out the oil dispersing aperture into the gearbox.

12. The method of claim 11, wherein the attaching step comprises connecting the tower lift rod to the head lift rod with a rotatable coupler adapter.

13. The method of claim 12, wherein the rotatable coupler adapter comprises an interior oil line.

14. The method of claim 1, wherein the introducing step comprises:
providing an oil tank attachable to the tower lift rod;
supplying a quantity of oil into the oil tank; and
pressurizing the oil tank with a gas so that pressurized oil flows from the tank, into the tower lift rod, through the head lift rod, and out the oil dispersion aperture into the gearbox.

15. The method of claim 14, wherein the pressuring gas is air.
